(19) United States
(12) Patent Application Publication
(10) Pub. No.: US 2005/0008094 A1
(43) Pub. Date: Jan. 13, 2005

(54) Method and circuit for crest factor reduction

(75) Inventors: Ronalf Kramer, Munchen (DE); Norbert Neurohr, Neuried (DE); Heinrich Schenk, Munchen (DE)

Correspondence Address: Maginot, Moore & Beck;Back One Tower, Suite 3000, 111 Monument Circle, Indianapolis, IN, 46204, US

(73) Assignee: Infineon Technologies AG, Munchen (DE)

(21) Appl. No.: 10/840,946

(22) Filed: May 7, 2004

(30) Foreign Application Priority Data
May 9, 2003 (DE) 103 20 917.4

(51) Int. Cl. H04L 27/28

(52) U.S. Cl. 375/296

(57) ABSTRACT

The invention relates to a method for production of a transmission signal with reduced crest factor having the following method steps: (a) Provision of a transmission signal which is to be transmitted and has at least one peak value in one area; (b) sampling, in particular oversampling of the transmission signal in order to produce sample values;
(c) buffer-storage and/or delay of the transmission signal s1(+) corresponding to the delay in the production of a correction function; (d) production of a weighted correction function by detection of whether the magnitude of the transmission signal or of its sample values has exceeded a first threshold in this area of the transmission signal; calculation of a correction factor; production of a weighted correction function from the correction factor and from a predetermined correction function; (e) additives superimposition of the weighted correction function and the delayed and/or buffer-stored transmission signal in order to produce the transmission signal with a reduced crest factor. The invention also relates to a circuit for crest factor reduction, to a circuit arrangement with such a circuit for crest factor reduction, and to a transmission system.

The invention relates to a method and an arrangement for crest factor reduction.

The present invention relates in general to data transmission systems and in particular to telecommunication systems for high-bit-rate data transmission. This high-bit-rate data transmission on a subscriber line is playing an ever increasing role in modern telecommunications, particularly because this promises to allow a greatly increased bandwidth for the data to be transmitted to be combined with bi-directional data communication. In an entirely general form, systems which allow such high-bit-rate digital data transmission have been in use for some time in the field of digital signal processing.

One technique which has become ever more important recently is so-called multicarrier transmission, which is also known as “Discrete Multitone (DMT)” transmission or “Orthogonal Frequency Division Multiplexing (OFDM)”. Such data transmission is used, for example, for cable-based systems, but also in the radio area, for broadcast systems and for access to data networks such as the Internet. Systems such as these for transmission of data by means of multicarrier transmission use a large number of carrier frequencies, in which case the data stream to be transmitted is broken down for data transmission into a large number of parallel stream elements, which are transmitted independently of one another using frequency-division multiplexing. These stream elements are also referred to as individual carriers.

One representative of multicarrier transmission is ADSL which stands for “Asymmetric Digital Subscriber Line”.

In this technique, the telecommunications line is subdivided into at least one channel for conventional telephone services (that is to say for speech transmission) and at least one further channel for data transmission, with a technique being used which allows the transmission of a high-bit-rate bit stream from a control center to the subscriber, and of a low-bit-rate bit stream which is carried from the subscriber to a control center. This transmission technique, which is based on an asymmetric bit rate, means that an ADSL system is particularly highly suitable for services such as Video on Demand, as well as for Internet applications.

Multicarrier transmission is implemented digitally. In this case, equidistant, orthogonally normalized carrier frequencies and square-wave transmission pulse forming are used for each orthogonal carrier. The sample values of the transmission signal at the symbol clock rate are then obtained from the transmission symbol vectors with the aid of inverse discrete Fourier transformation (IDFT) as follows:

$$s ( i ( ( i ( \frac{1}{\sqrt{M}} {{‡}^{″}}_{{n}_{1} 0}^{M 1} {X}_{k} ( i ) {ⅈ}^{j 2 n j n / M} , where 0 ; \ddot{U} k < M .$$

After interpolation and digital/analog conversion, this results in the analog transmission signal. In the receiver, the reception vectors are obtained from the sample values of the received signal with the aid of discrete Fourier transformation (DFT).

Although multicarrier transmission systems such as ADSL have already solved a large number of problems, there are still some unresolved problems.

Since the transmission signal for multicarrier data transmission comprises a large number of complex-value sinusoidal oscillations with a random phase, this results in a Gaussian distribution for the probability density of the amplitude, in accordance with the central limit theorem. One problem associated with this results from the fact that the superimposition of a very large number of individual carriers means that, in the short term, they may add up to very high peak values. The ratio of the peak value to the root mean square value is referred to as the crest factor, and its square is referred to as the PAR (Peak to Average Ratio). Although these peak values, at the amplitude level that results from this, are typically present only for very short time periods, they represent a major disadvantage of multicarrier data transmission. Particularly in the case of multicarrier systems such as ADSL, the crest factor may become very large—for example greater than 6.

A crest factor which is as high as this causes various problems in the overall data transmission system:

The maximum possible drive control of the digital/analog converters and of the analog circuit parts, for example filters and line drivers, must be designed, in terms of their drive range and their dynamic response and resolution, for the maximum peak values that occur. This means that these circuit parts must be designed to be considerably larger than the effective drive level. This involves a correspondingly high operating voltage, which also directly leads to a high power loss. Particularly in the case of line drivers, whose non-linearity is generally not negligible, this leads to distortion of the signal to be transmitted. The components which are produced as a consequence of this in the signal to be transmitted and which thus also occur in the echo signal cannot, in principle, be compensated for by linear echo compensation. The resultant echo compensation thus becomes considerably worse.

A further problem of data transmission with high crest factors is that the very high peak values of the transmission signals may exceed the maximum possible drive levels. In this case, the transmission signal is limited, and this is referred to as clipping. However, in these cases, the transmission signal no longer represents the original transmission signal sequence, so that transmission errors occur. Furthermore, faulty echo compensation typically occurs at these peak values, since the echo results from the limited signal, but the echo compensation signal is derived from the unlimited signal. This leads to reception errors which, however, should be avoided.

For this reason, there is a major requirement in multicarrier transmission systems such as these to suppress or to prevent such peak values as far as possible. In the literature, this problem is known by the expression crest factor reduction or else PAR reduction.

Numerous methods for crest factor reduction are described in the literature:

Most methods require a certain amount of redundancy, but allow the crest factor to be reduced without any disturbance. The method which is described in the article by A. E. Jones, T. A. Wilkinson, S. K. Barton, “Block Coding Scheme for Reduction of Peak to Mean Envelope Power Ratio of Multicarrier Transmission Schemes”, Electronic Letters, Vol. 30. No. 25, 1994 is based on coding of the information, which allows only those code words which lead to transmission signals with a low crest factor. In the case of the method which is described in the article by S. H. Muller, J. B. Huber, “A comparison of Peak Power Reduction Schemes for OFDM”, Proc. Globecom, 1997, a number of transmission signals with different phase relationships are produced, and the transmission signal with the lowest crest factor is selected for transmission. The disadvantage of these two methods apart from the fact that in some cases they are highly complex, is that they require measures in the transmitter and in the receiver and generally do not comply with the appropriate data transmission standards.

In a further, known, method, which does comply with the standards, some of the carriers from the multicarrier transmission system are reserved, and are then no longer available for data transmission. This means that these carrier positions are initially set to zero. A function in the time domain with a peak value which is as high as possible but lasts for only a short time is produced from these reserved or unused carriers and forms the compensation signal—the so-called kernel—in order in this way to reduce the crest factor. This kernel, which is filled only with the reserved carriers, is then weighted iteratively with an amplitude factor which is proportional to the difference between the maximum peak value and the desired maximum value, and is then subtracted iteratively in the time domain. In the process, the kernel is shifted cyclically to that point on the corresponding peak value which is responsible for the excessive crest factor. The shift rule for DFT transformation ensures that only the reserved carriers are used, even after the shift.

This method for crest factor reduction advantageously operates only in the time domain, and is thus characterized by a very low level of complexity.

However, carrier frequencies which are in the frequency range of the carrier frequencies for general data transmission are used for crest factor reduction, and this can reduce the maximum data rate that can be transmitted.

The power of this method also depends on the number of free carriers and their being distributed as well as possible over the entire frequency range. Furthermore, the method requires a high degree of implementation complexity, particularly when it is used in an extended form, including transmission filtering, so that it is suitable only to a limited extent for practical application.

The present invention is thus based on the object of specifying a circuit which is as simple as possible and a method which is as simple as possible for crest factor reduction.

According to the invention, this object is achieved by a method having the features of patent claim 1, by a circuit for crest factor reduction having the features of patent claim 10, by a circuit arrangement for carrying out the features of patent claim 21, and by a transmission system having the features of patent claim 23. This results in:

A method for production of a transmission signal with reduced crest factor having the following method steps:
(a) Provision of a transmission signal which is to be transmitted and has at least one peak value in one area;
(b) sampling, in particular oversampling of the transmission signal in order to produce sample values;
(c) buffer-storage and/or delay of the transmission signal corresponding to the delay in the production of a correction function;
(d) production of a weighted correction function by detection of whether the magnitude of the transmission signal or of its sample values has exceeded a first threshold in this area of the transmission signal, calculation of a correction factor, production of the weighted correction function from the correction factor and from a predetermined correction function;
(e) additives superimposition of the weighted correction function and the delayed and/or buffer-stored transmission signal in order to produce the transmission signal with a reduced crest factor. (patent claim 1).

A circuit for crest factor reduction of a signal which is to be transmitted by a data transmission system,
having an input into which the signal to be transmitted can be coupled, and an output from which a signal with a reduced crest factor can be tapped off,
having a transmission path which is arranged between the input and the output, and in which a delay element is arranged, which delays the signal which is to be transmitted by a signal delay time period, and/or buffer stores it for the signal delay time period,
having a compensation path, which is arranged between the input and the output, is connected in parallel with the transmission path and has an extraction device which extracts the magnitude of a peak value from the signal which is to be transmitted, and which has a first filter, which is connected in series downstream, filters the extracted signal and produces a compensation signal.
having an adding device, which is connected downstream from the compensation path and from the transmission path, and uses the delayed signal and the compensation signal to produce the signal with a reduced crest factor. (patent claim 10)

A circuit arrangement having at least two circuits for crest factor reduction according to the invention, whose inputs and outputs are arranged in series with one another. (patent claim 21)

A multicarrier data transmission system, having a transmission path which is arranged between a transmitter and at least one transmission line, and in which a digital/analog converter for conversion of a digital data symbol, which is to be transmitted, to an analog data symbol, and a line driver for driving the analog data symbol via the transmission line are arranged, having a circuit for crest factor reduction, which is arranged in the transmission path upstream of the digital/analog converter and produces a compensation signal for reduction of the crest factor of the data symbol which is to be transmitted. (patent claim 23)

The present invention describes a circuit and a method, by means of which a correction signal is additively superimposed on the (oversampled) signal to be transmitted, which correction signal comprises correction functions which are limited in time and are concentrated around the peak values that occur, and which reduce the individual peak values in the signal to be transmitted.

The superimposition of the correction signal typically takes place after the oversampling and advantageously before the digital/analog conversion of the transmission signal. This correction signal is also created such that it has only a narrow effective bandwidth, and its mid-frequency is in a frequency range in which only a small amount of data, or in the ideal case no data whatsoever, is transmitted.

However, this method is subject to disturbances. By suitable selection and adaptive matching of the effective bandwidth and of the mid-frequency of the correction signal, the effect of any disturbance on the performance of the transmission system using this correction method can advantageously be limited.

The method according to the invention and the circuits according to the invention are distinguished by an extraordinarily low degree of implementation complexity. Particularly when bandpass filters are used, a relatively small number of coefficients are required, typically in the region of 40 coefficients. Particularly if the clipping level can be programmed in the circuit for crest factor reduction or in the clipping apparatus, the circuit for crest factor reduction can be matched very advantageously to different line drivers, or may even be switched off completely, without any need to modify a complex algorithm for this purpose.

The correction factor can also advantageously be varied or adjusted in the correction device.

Advantageous refinements and developments can be found in the dependent claims and in the description, with reference to the drawing.

The invention will be explained in more detail in the following text with reference to the exemplary embodiments which are illustrated in the figures of the drawing, in which:

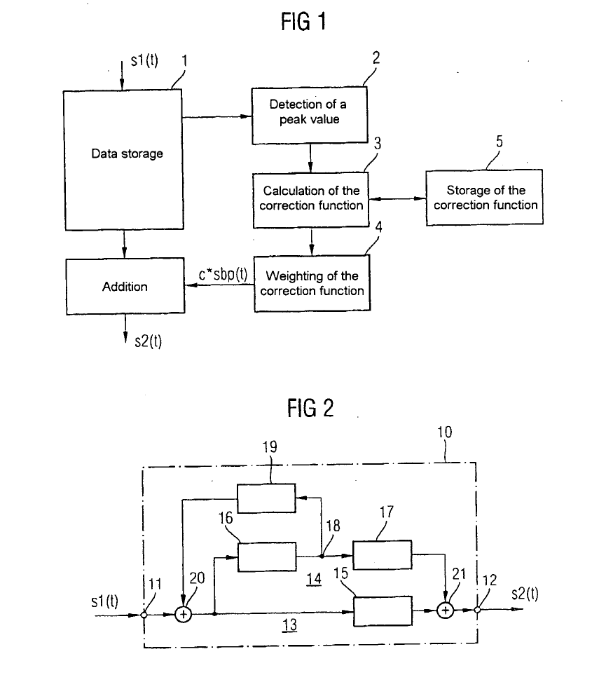

FIG. 1 uses a block diagram to show the basic procedure for a method according to the invention for reduction of the crest factor or of a peak value in a signal sequence to be transmitted;

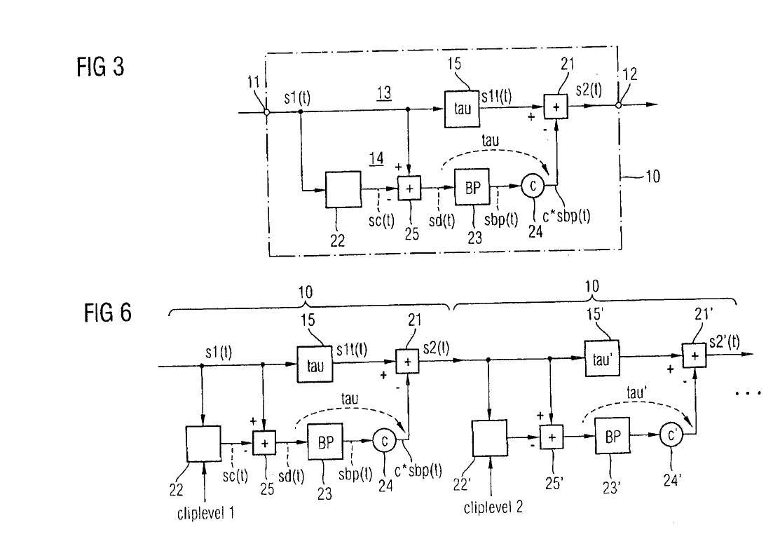

FIG. 2 uses a block diagram to show a first exemplary embodiment of a circuit according to the invention for crest factor reduction;

FIG. 3 uses a block diagram to show a second exemplary embodiment of a circuit according to the invention for crest factor reduction;

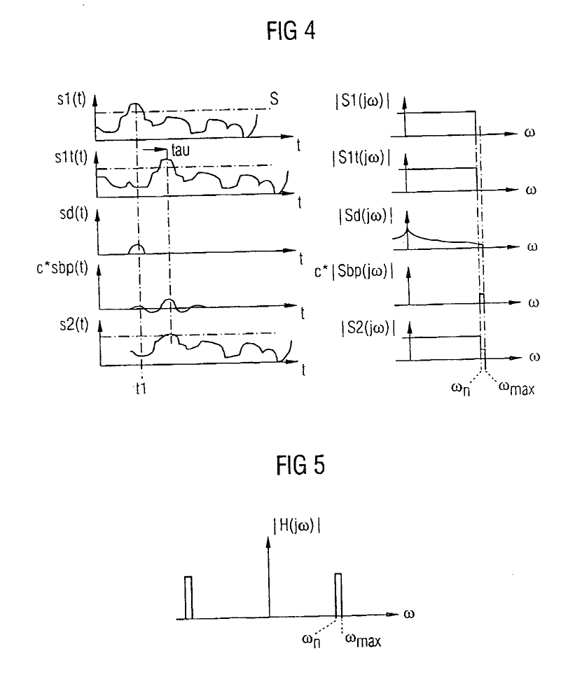

FIG. 4 shows signal/time diagrams and the corresponding frequency responses for the circuit for crest factor reduction as shown in FIG. 3;

FIG. 5 shows the absolute signal value and the magnitude of the frequency response in the bandpass filter shown in FIG. 3;

FIG. 6 shows a first development of the second exemplary embodiment of a circuit according to the invention for crest factor reduction;

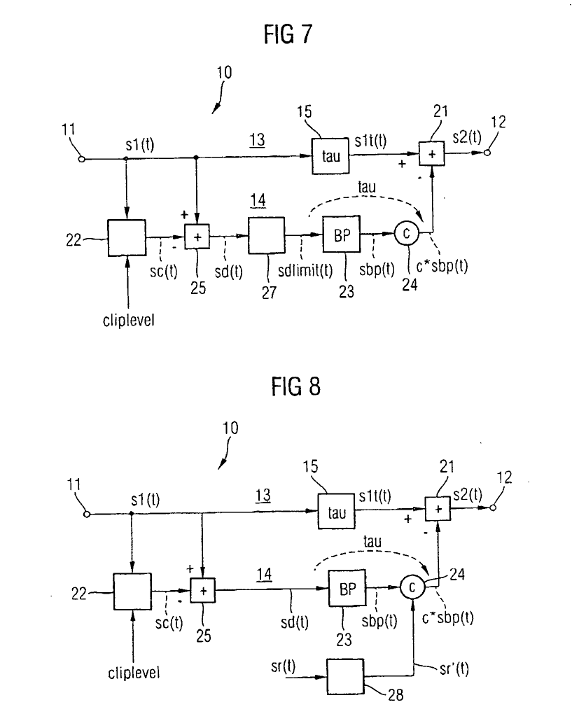

FIG. 7 shows a second development of the second exemplary embodiment of a circuit according to the invention for crest factor reduction;

FIG. 8 shows a third development of the second exemplary embodiment of a circuit according to the invention for crest factor reduction;

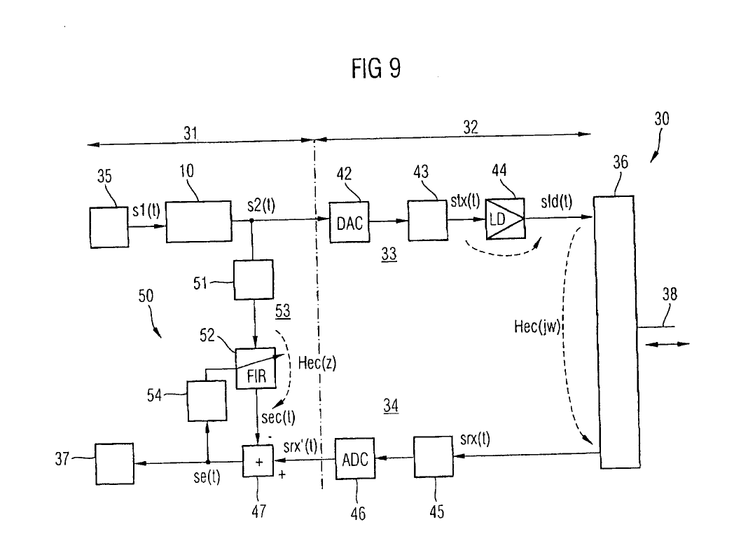

FIG. 9 shows a transmission system with a circuit for crest factor reduction according to the invention.

Identical or functionally identical elements have been identified in the same way in all of the figures of the drawing, except where stated to the contrary.

FIG. 1 uses a block diagram to show the basic procedure for a method according to the invention for reduction of the crest factor or of a peak value in a signal sequence to be transmitted. The incoming sample values of the transmission signal s1(t) are buffer-stored corresponding to the length of a correction function in a delay element 1, or are delayed by the duration of the peak value detection and correction function calculation. A detection unit 2 is used to detect whether a peak value, that is to say a local maximum/minimum, whose magnitude exceeds a specific threshold S, is present in this area. If necessary, a correction function is calculated in a computation unit 3 and, if required, the correction function is weighted by a factor in a correction unit 4. The sample values of the correction function may be stored in a memory 5. The symmetry of the correction function is advantageously used in this case. The weighted correction function c*sbp(t) is then additively superimposed on the transmission signal s1(t) that is stored or buffer-stored in the delay device, and is emitted as a signal s2(t) with a reduced crest factor.

FIG. 2 uses a block diagram to show a first exemplary embodiment of one possible implementation of this peak value reduction.

In FIG. 2, the reference symbol 10 denotes the circuit for crest factor reduction (referred to in the following text as the CF circuit). The CF circuit 10 contains an input 11 and an output 12, with the digital symbol sequence s1(t) to be transmitted being input into the input 11, and in which case the digital symbol sequence s2(t) with the reduced crest factor can be tapped off from the output 12. The CF circuit 10 has a signal path 13 and a compensation path 14 which is arranged in parallel with it. A delay device 15 is provided in the signal path 13. The delay device 15 may, for example be in the form of a FIFO memory (corresponding to the block 1 in FIG. 1). The delay device 15 is used for the purpose of compensating for a signal propagation time delay in the compensation path 14.

An extraction device 16 and a (bandpass) filter 17 are arranged successively in the compensation path 14. The signal which is extracted from the extraction device 16 is tapped off and fed back at a tap 18 between the extraction device 16 and the filter 17. A further (bandpass) filter 19 is provided in this feedback path. The signal which has been fed back and filtered in this way is supplied additively to an adding device 20 at the input 11, to which the input signal s1(t) is also supplied. The signals from the signal path 13 and from the compensation path 14 are added to one another in an adding device 21 at the output 12, so that this results in the signal s2(t) with a reduced crest factor.

The method of operation of the circuit 10 for crest factor reduction will be described in more detail in the following text:

First of all, a peak value is extracted in the circuit for crest factor reduction 10. This is done not only by comparing the sample values with the threshold, but also by checking whether the magnitude of the next value is in each case greater or smaller. This results in a pulse, which is similar to a dirac, at the time of occurrence of a local maximum/minimum whose magnitude exceeds the threshold. The correction function is now calculated and weighted from the filtering of this pulse which is similar to a dirac with a cosine-modulated window function (a bandpass filter). The “causal” component of the filtering is then fed back and is additively superimposed on the incoming transmission signal s1(t). Subsequent values whose magnitudes exceed the threshold are thus correct in this way. The “acausal” component of the filtering is then additively superimposed on the correspondingly delayed output transmission signal. This corrects previous values whose magnitudes exceeded the threshold.

The method which is used in the circuit according to the invention for crest factor reduction 10 is based on physical knowledge and relationships which will be explained briefly in the following text:

A correction signal c(i) which comprises correction functions g(i−iₙ) which are limited in time, are weighted and are concentrated around the peak values that occur is additively superimposed on the (oversampled) transmission signal s(i) (before the digital/analog conversion). In this case, the sample values are denoted i. This results in the output signal s_{c}(i):
s_{c}(i)=s(i)+c(i)
with the correction signal:

$$c ( i ) = {\sum }_{n = - ∞}^{+ ∞} {a}_{n} g ( i - {i}_{n} )$$

The signal s(i) corresponds to the signal s1(t), c(i) corresponds to c*sbp(t) and s_{c}(i) corresponds to s2(t).

The time in of occurrence of a peak value is for this purpose first of all determined (in the appropriate time pattern) that is to say the position of a local maximum/minimum whose magnitude exceeds a specific threshold S. The weighting factor aₙ is then determined such that the peak value is reduced:
aₙ=−sgn(s(iₙ))·(|s(iₙ)|−S)

The correction function g(i) is, in the general case, independent of the respective peak value, and is obtained from the windowing w(i) of a cosine oscillation (cosine modulation of a window function):
g(i)=cos(2π(f₀/fₐ)·i)·w(i)

The frequency f₀ of the cosine oscillation with respect to the sampling frequency fₐ is obtained from the desired mid-frequency of the correction function g(i). The window function w(i) is time-limited, has the maximum value 1 at the origin, and is selected such that the product of the effective duration and the effective bandwidth is as small as possible. One suitable window function w(i) is, for example, the Gaussian function:

$$w ( i ) = {ⅇ}^{- \frac{{i}^{2}}{{d}^{2}}}$$

where d is a constant.

For the Gaussian function, the product of the effective duration and the effective bandwidth is a minimum. Since the Gaussian function is neither time-limited nor band-limited, the Gaussian function is restricted in the time domain. In this case, symmetrical barriers are selected such that the Gaussian function has already decayed sufficiently within the barriers. The windowed cosine oscillation can be calculated in advance and can be stored, in which case the symmetry of the window function may be used.

Accurate determination of the time and of the magnitude of a peak value can be carried out best when a high degree of oversampling is used. However, a lower degree of oversampling requires less implementation complexity. Good correction for a peak value without disadvantageous influencing of adjacent values, that is to say possible production of new peaks, is best achieved by a correction function which has a short effective duration and a low mid-frequency. A correction function with a short effective duration also requires little implementation complexity. The performance of the transmission is, however, less restricted by selecting a correction function with a narrow effective bandwidth and thus a longer effective duration, and by the mid-frequency being in a frequency range in which only a small amount of data, or no data at all, is transmitted. However, the effective duration must not be so long that there is a high degree of probability of a correction function being superimposed on two adjacent multicarrier transmission symbols. Furthermore, the mid-frequency must be selected such that the spectral mask of the respective system is satisfied.

In a more specific form of this method, the correction function gₙ(i) is matched to the respective peak value by determination of the corresponding phase φₙ of the cosine oscillation.

$$\begin{matrix}{g}_{n} ( i ) = ( {c}_{n} \cdot cos ( 2 π ( {f}_{0} / {f}_{a} ) \cdot i + {φ}_{n} ) ) \cdot w ( i ) \\ = ( {c}_{0 , n} cos ( 2 π ( {f}_{0} / {f}_{a} ) \cdot i ) + {c}_{1 , n} sin ( 2 π ( {f}_{0} / {f}_{a} ) \cdot i ) ) \cdot w ( i )\end{matrix}$$

$$where$$

$${c}_{n} = \sqrt{{c}_{0 , n}^{2} + {c}_{1 , n}^{2} ;} {φ}_{n} = arctan ( {c}_{1 , n} / {c}_{0 , n} )$$

The window function w(i) is for this purpose modulated with a linear combination of a sinusoidal oscillation and a cosine oscillation at the frequency f₀ with respect to the sampling frequency fₐ. The windowed cosine oscillation or sinusoidal oscillation may be calculated in advance, and may be stored. The symmetry of the window function may be used in this case. The coefficients are determined such that the carrier oscillation approximates as well as possible to a small area around the respective peak value. For this purpose, an equation system is produced as a function of the peak value and of a number of adjacent values, including the values either relative to the threshold S or normalized with respect to the peak value:

$$\underbrace{( \vert \begin{matrix} & 1 & 0 \\ cos ( 2 π ( {f}_{o} / {f}_{a} ) ) & & sin ( 2 π ( {f}_{0} / {f}_{a} ) ) \\ cos ( 4 π ( {f}_{0} / {f}_{a} ) ) & & sin ( 4 π ( {f}_{0} / {f}_{a} ) )\end{matrix} )}_{A} \cdot \underbrace{( \begin{matrix}{c}_{0 , n} \\ {c}_{1 , n}\end{matrix} )}_{c} = \underbrace{\vert ( \begin{matrix}s ( {i}_{n} - 1 ) \\ s ( {i}_{n} ) \\ s ( {i}_{n} + 1 )\end{matrix} ) \vert - S ,}_{y}$$

or, respectively

$$\underbrace{( \vert \begin{matrix} & 1 & 0 \\ cos ( 2 π ( {f}_{o} / {f}_{a} ) ) & & sin ( 2 π ( {f}_{0} / {f}_{a} ) ) \\ cos ( 4 π ( {f}_{0} / {f}_{a} ) ) & & sin ( 4 π ( {f}_{0} / {f}_{a} ) )\end{matrix} )}_{A} \cdot \underbrace{( \begin{matrix}{c}_{0 , n} \\ {c}_{1 , n}\end{matrix} )}_{c} = \underbrace{\vert ( \begin{matrix}s ( {i}_{n} - 1 ) \\ s ( {i}_{n} ) \\ s ( {i}_{n} + 1 )\end{matrix} ) \vert \cdot \frac{1}{\vert s ( {i}_{n} ) \vert}}_{y}$$

Two adjacent values are taken into account in this example, although even more adjacent values may also be taken into account. The solution to this (overdefined) equation system where the minimum square error can be determined with the aid of the pseudoinverses:

$$c = ( {( {A}^{T} \cdot A )}^{- 1} \cdot {A}^{T} ) \cdot y = ( \begin{matrix}0.8153 & 0.3413 & - 0.1847 \\ - 1.0765 & 0.1414 & 1.3377\end{matrix} ) \cdot y$$

The pseudoinverse depends only on the number of values taken into account and on the frequency f₀. It can thus be calculated in advance, and stored. In this example, the pseudoinverse is shown for 3 values that have been taken into account and for
f₀/fₐ=1/16

The weighting factor aₙ is then determined as a function of the production of the equation system such that the peak value is reduced:
aₙ=−sgn(s(in))
or, respectively:
aₙ=−sgn(s(iₙ))·(|s(iₙ)|−S)

Thus, in general, the correction signal is obtained from the addition of a sinusoidal function and a cosine function at a specific frequency.

FIG. 3 uses a block diagram to show a second exemplary embodiment of a CF circuit according to the invention.

In contrast to the CF circuit 10 in the exemplary embodiment in FIG. 2, the CF circuit 10 in this case has a clipping device 22, a bandpass filter 23 and a correction device 24 successively in the compensation path 14. In this case, there is no feedback in the compensation path 14. The clipping device 22 clips those areas of the transmission signal s1(t) which are above a predetermined limit S. This threshold S is advantageously variable or can be adjusted, for example by programming. The signal sc(t) which has been changed in this way is subtracted from the digital input signal s1(t) in an adding device 25 which is arranged between the clipping device 22 and the bandpass filter 23. The signal sd(t) produced in this way is supplied to the bandpass filter 23, which produces the bandpass-filtered signal sbp(t), which is multiplied by a correction factor c in the correction device 24. The correction factor c is also advantageously variable or can be adjusted. This results in the compensation signal c*sbp(t). This compensation signal c*sbp(t) is subtracted from the delayed input signal s1t(t) in the adding device 21. The output signal s2(t) with a reduced crest factor that results from this can be tapped off at the output 12.

The method of operation of the circuit for crest factor reduction 10 in FIG. 3 will be explained in the following text with reference to FIG. 4. FIG. 4 shows signal/time diagrams and the corresponding frequency responses to these signals within the CF circuit 10 shown in FIG. 3. In this case, for simplicity, all of the signal sequences are shown as being continuous in the time domain and as being continuous in the frequency domain. In reality, the sampling frequency of all the signal sequences is greater than or at least equal to 2*ωₘₐₓ, and the spectrum is discrete, corresponding to the carrier frequency that is used.

The following precondition for the signal sequence s1(t) must be satisfied in order to make it possible to carry out the method for crest factor reduction: when the digital signal sequence s1(t) is produced in the transmitter, only frequencies up to the maximum frequency ωₙ may be used, which is less than the fundamentally permissible maximum frequency ωₘₐₓ (bandwidth) of the data transmission method, so that the frequency spectrum s1(jω) of the signal sequence s1(t) is equal to zero for ω>ωₙ (see FIG. 5). In the CF circuit 10 according to the invention, so-called clipping of the transmission signal s1(t) is first of all carried out on the basis of a clipping threshold. Clipping comprising limiting of the corresponding signal s1(t) to the clip level or threshold S. This clipping threshold S corresponds, for example, to a maximum possible drive control of a digital/analog converter and line driver which may be connected downstream from these CF circuits 10. The clipping results in a signal sequence sc(t), which is subtracted from the input-side signal s1(t). After subtraction from the signal s1(t), the “clipped” part sd(t) is obtained from the signal sequence s1(t). Since the clipping is a non-linear process, the signal sd(t) also contains spectral components above the frequency ωₙ. The signal sd(t) is now filtered in the bandpass filter 23, with the bandpass filter response illustrated in FIG. 5. The bandpass-filtered signal sequence sbp(t) which is produced from this is multiplied in the correction device 24 by a typically constant factor c. The factor c is in this case a scaling factor, which is typically but not necessarily chosen to be less than unity. The bandpass filtering and the scaling by the factor c results in the compensation signal c*sbp(t), which is delayed by the group delay time tau in comparison to the signal s1(t) which was input on the input side. This digital signal sequence s1(t) is thus likewise delayed by tau in the signal path 13, so that this results in the delayed digital signal s1t(t). The compensation signal c*sbp(t) is subtracted from the delayed signal s1t(t) in the adding device 21 at the output 12. The signal s2(t) which results from this thus has a reduced crest factor, that is to say its peak values are at least reduced.

While the spectrum s1(jω) which is evaluated and used by the receiver of the data transmission extends only up to the frequency ωₙ, the frequency spectrum s2(jω) of the output signal s2(t) with a reduced crest factor now extends up to ωₘₐₓ. An additional spectrum—the so-called peak reduction spectrum, is thus also added to the useful spectrum s1(jω). The corresponding signal in the time domain for this additional spectrum is the compensation signal c*sbp(t).

Since, in practice, the digital signal sequence s1(t) always exceeds the clipping level S in a finite time interval only in a single sample value, but in practice never exceeds it at two successive sample values, the signal sd(t) thus also always has only a single value that is not zero. The bandpass-filtered signal sbp(t) is then equal to the impulse response of the bandpass filter 23.

On the assumption that the resultant difference signal is a weighted dirac pulse, this is a further possible implementation of the method that has been described above with reference to FIG. 1. If the resultant difference signal is not a direct pulse, two or more correction functions are superimposed, and the filtered difference signal must also be multiplied by a correction factor.

In addition to the oversampling, the effective duration and the effective bandwidth as well as the mid-frequency of the correction functions, the threshold of the peak value detection is also a parameter in this method. The lower the threshold, the greater the extent to which existing peak values can be reduced, but the greater is also the probability of producing new peak values. However, the method may also be carried out in a number of iteration steps, with the threshold that is used possibly being varied. Furthermore, the method may, of course, also be combined with one of the disturbance-free methods mentioned above in order to further reduce the remaining peak values.

In contrast to the exemplary embodiment in FIG. 3, two CF circuits 10, 10′ are provided in the block diagram shown in FIG. 6, and are arranged in series with one another. The output signal s2(t) with a reduced crest factor from the first CF circuit 10 is in this case used as the input signal for the second CF circuit 10′, which is connected in series downstream. The second CF circuit 10′ thus produces a signal s2′(t) on the output side, whose peak values have been reduced even further. Depending on the requirement and the application, even more CF circuits may, furthermore be connected downstream in series. A greater overall reduction of the peak values can be achieved by means of two or more CF circuits 10, 10′ connected in series in this way.

This connection of two or more CF circuits 10, 10′ in series, is, furthermore, based on the knowledge that the crest factor reduction within a CF circuit 10, 10′ allows further peak values to be generated, in particular in the immediate vicinity of these peak values whose crest factor has been reduced. This occurs in particular when the selected clipping threshold S in the clipping apparatus 22 has been selected to be very low, in order to compensate for very high peaks in this way. The connection of two or more CF circuits 10, 10′ in series allows their clipping threshold S to be chosen to be increasingly lower, starting with a high threshold S. The peak values which occur in the entire input symbol sequence s1(t) can thus be successively reduced ever further, starting with the high peaks. Advantageously, in this case:
cliplevel1≧cliplevel2≧. . .

In contrast to the exemplary embodiment shown in FIG. 3, a limiter 27 is arranged between the adding device 25 and the bandpass filter 23 in the exemplary embodiment shown in FIG. 7. The limiter 27 uses the signal sd(t) to produce a limited signal sdlimit(t). The limiter 27 results in very high peaks in the input signal s1(t), which are thus also evident in the clipped signal sd(t), not being reduced to such an extent as medium-level or small peaks. This avoids the compensation signal c*sbp(t) and thus also the corresponding compensation spectrum becoming so large that further undesirable peaks are produced in the vicinity of large peaks, thus making the reduction worse overall. The amplitude distribution is thus greatly reduced between the value of the clipping level and the limiter value, so that the amplitude probability is no longer reduced so greatly above the limiter value at which the distribution has a low value in any case.

If a peak occurs at the end of a frame for data transmission then it is possible for a part of the compensation signal c*sbp(t) which is produced on the basis of the peak to fall in the next data transmission frame. However, this is undesirable since the compensation signal c*sbp(t) is intended to reduce only a peak in one particular frame, but not in a subsequent frame, since this can lead to distortion of the data transmission. In order to prevent this, the constant c can be appropriately controlled in the correction device 24 by means of a frame signal which is also supplied from the transmitter. In particular, the constant c may be set to be less than or even equal to zero.

The exemplary embodiment in FIG. 8 shows a CF circuit 10 which allows the constant c to be adjusted by means of a frame-controlled signal sr′(t). A delay device 28 is typically used here, to which the frame signal sr(t) is supplied, and which drives the correction device 24 with a suitable frame-controled signal sr′(t) based on this.

FIG. 9 uses a block diagram to show a simplified transmission system which has an arrangement for crest factor reduction according to the invention.

In FIG. 9, the reference symbol 30 denotes the transmission system. The transmission system comprises a digital part 31 and an analog part 32. The transmission system 30 furthermore contains a transmission path 33 and a reception path 34. The transmission path 33 is arranged between an output of a transmitter 35 and an input of a hybrid circuit 36, while, in contrast, the reception path 34 is provided between an output of the hybrid circuit 36 and an input of a receiver 37. The transmitter 35 and the receiver 37 are each provided in the digital part 31, and the hybrid circuit 36 is provided in the analog part 32, of the transmission system 30. The hybrid circuit 36 is typically in the form of a passive RC network with a transformer, and is used for physical isolation of the transmission path 33 from the reception path 34. On the output side, the hybrid circuit 36 is connected to a line 38 (telephone line) for speech or data transmission.

The CF circuit 10 according to the invention, a digital/analog converter 42, an analog filter 43 and a line driver 44 are arranged successively in the transmission path 33 to the transmitter 35. In the reception path 34, an analog filter 45, an analog/digital converter 46 and an adding device 47 are connected downstream from the hybrid circuit 36 on the output side, and are connected upstream of the receiver 37. Further filters for stepping up the signal to be transmitted and/or for stepping down the received signal, as well as filters in the echo path, have been omitted from FIG. 9, in order to make the figure clearer.

The digital/analog converter 42 as well as the analog/digital converter 46 are used for signal conversion between the digital part 31 and the analog part 32, and vice versa. The analog filter 43 in the present example is in the form of a low-pass filter, which removes steps or discontinuities from the output signal produced by the digital/analog converter 42. The low-pass filter 43, which is also referred to as an anti-image filter, is thus used to smooth the analog transmission signal. The analog filter 45 in the reception path 34 is in the form of a so-called anti-aliasing filter. This analog filter 45 filters out those frequencies from the reception-end signal srx(t) which would result in a change to the sampling theorem in the analog/digital converter 46.

The transmission system 30 advantageously furthermore has a circuit for echo compensation 50, which is arranged in the digital part 31 between the transmission path 33 and the reception path 34. This circuit arrangement 50 has a delay device 51 and a filter 52—for example an FIR filter—which are arranged in series with one another and which form an echo path 53. The echo path 53 is arranged between the output of the CF circuit 10 according to the invention and the adding device 47. The control element 54 is connected on the input side to the output of the adding device 47, and on the output side controls the FIR filter 52 by means of a signal which is derived from the echo-compensated signal se(t) so as to set the filter coefficients of the FIR filter 52 appropriately.

The method of operation of the transmission system 30 illustrated in FIG. 9 will be explained in more detail in the following text.

The transmitter 35 in the transmission path 33 produces a digital symbol sequence s1(t) which is supplied to the CF circuit 30, which uses it to produce the signal s2(t) in the transmission path 33. Once the signal s2(t) has been converted from digital to analog form and has passed through the low-pass filter 43, this results in a transmission signal stx(t), which is amplified in the line driver 44, so that this results in the signal sld(t), which is supplied to the input of the downstream hybrid circuit 36. This signal sld(t) is transmitted on the line 38 via the hybrid circuit 36.

The compensation signal c*sbp(t) changes the signal sl(t), and this once again leads to an echo element. The total echo, which also includes this echo element, should be compensated for the echo compensation. For this purpose, the signal s2(t) with reduced crest factor and which is tapped off after the CF circuit 10 is supplied to the FIR filter 52 in the second echo path 53, which uses it to produce the echo compensation signal sec(t). This echo compensation signal sec(t) is subtracted from the digital signal srx′(t) in the adding device 47. This results in the received signal se(t).

Although the present invention has been described above with reference to preferred exemplary embodiments, it is not restricted to them but can be modified in many ways.

The invention is not restricted to the above data transmission systems, but may be extended for the purpose of crest factor reduction to all data transmission systems, in particular to systems and methods based on multicarrier data transmission. In particular, the invention is not restricted to ADSL data transmission, but can be extended to all xDSL data transmissions.

In addition, circuit examples of the CF circuit have been specified in the above exemplary embodiments. It is self-evident that the functionality of the CF circuit or parts of it can be implemented by a software function which, for example, is implemented in a programmable unit (micro controller, microprocessor) in the transmission system.

1-24. (Cancelled)

25. A method for reducing a crest factor in a transmission signal, the method comprising:
(a) providing an input transmission signal having at least one peak value in one area;
(b) sampling the input transmission signal in order to produce sample values;
(c) storing and/or delaying the input transmission signal corresponding to a delay associated with providing a weighted correction function;
(d) providing the weighted correction function by:
(d1) detecting whether a magnitude of the input transmission signal or of its sample values has exceeded a first threshold;
(d2) providing a correction factor;
(d3) producing the weighted correction function based on the at least in part on the correction factor and a predetermined correction function;
(e) additively superimposing the weighted correction function and the delayed and/or stored input transmission signal in order to produce an output transmission signal with a reduced crest factor.

26. The method of claim 25 wherein the weighted correction function comprises a symmetrical correction signal.

27. The method of claim 25 wherein step d3 further comprises superimposing a pulse which is similar to a dirac and has a window function in order to produce the weighted correction function.

28. The method of claim 27 wherein step d3 further comprises superimposing a bandpass filter.

29. The method of claim 25 wherein the weighted correction function is obtained from the equation
$$c ( i ) = {\sum }_{n = - ∞}^{+ ∞} {a}_{n} g ( i - {i}_{n} )$$
where iₙ denotes the time of occurrence of a peak value, aₙ denotes the weighting factor and g(i) denotes the correction function.

30. The method of claim 25 wherein the weighted correction function is obtained from the cosine-modulated window function
g(i)=cos(2n(f₀/fₐ)i)w(i)
where the frequency f₀ of the cosine oscillation divided by the sampling frequency fₐ is derived from the mean frequency of the correction function.

31. The method of claim 30 wherein a Gaussian function is used as the window function.

32. The method of claim 30 wherein the correction function is matched to the respective peak value by determination and use of the phase of the cosine oscillation, with the window function for this purpose being modulated with a linear combination of a sinusoidal oscillation and a cosine oscillation at the frequency f₀ with respect to the sampling frequency fₐ.

33. The method of claim 30 wherein the windowed cosine oscillation or sinusoidal oscillation is calculated in advance using the symmetry of the window function, and is stored.

34. The method of claim 25 wherein the sample values of the correction function and/or of the transmission signal are stored in a memory.

35. A circuit for crest factor reduction of an input signal which is to be transmitted by a data transmission system, the circuit comprising:
an input configured to receive the input signal to be transmitted, and an output configured to provide an output signal with a reduced crest factor;
a transmission path arranged between the input and the output, the transmission path including a delay element operable to delay the input signal by a signal delay time period and/or store the input signal for the signal delay time period;
a compensation path arranged between the input and the output, the compensation path connected in parallel with the transmission path and comprises an extraction device operable to extract the magnitude of a peak value from the input signal, the compensation path also including a first filter operable to filter the extracted signal and produce a compensation signal;
an adding device connected to the compensation path and the transmission path, the adding device operable to use the delayed input signal and the compensation signal to produce the output signal with a reduced crest factor.

36. The circuit of claim 35 wherein the delay element is in the form of a FIFO.

37. The circuit of claim 35 wherein the signal delay time period corresponds to the delay period of a signal in the compensation path.

38. The circuit of claim 35 wherein a feedback path is provided with a second filter arranged and disposed in the feedback path, the bandpass filter operable to filter the extracted signal that is produced by the extraction device and superimposes the input signal on it.

39. The circuit of claim 35 wherein the first filter and the second filter are in the form of bandpass filters.

40. The circuit of claim 35 further comprising a scaling device provided in the compensation path, the scaling device operable to scale the filtered signal produced by the first filter by a correction factor, and thus produce the compensation signal.

41. The circuit of claim 35 wherein the extraction device provides a first threshold above which the peak values of the input signal are extracted.

42. The circuit of claim 35 wherein the extraction device comprises a clipping device operable to clip off a peak of the input signal if the magnitude of the input signal exceeds a first threshold, the clipping device further operable to draw off the clipped-off input signal from the input signal in order to produce the extracted signal.

43. The circuit of claim 35 wherein the adding device is in the form of a subtraction device in which the compensation signal is subtracted from the delayed input signal.

44. The circuit of claim 35 further comprising a limiter circuit provided between the extraction device and the first filter, the limiter operable to limit the amplitude of the extracted signal to a maximum amplitude.

45. The circuit of claim 40 further comprising a delay device connected to the scaling device, the delay device driving the scaling device with a frame-controlled signal which is derived from a frame of the input signal.

46. The circuit arrangement of claim 35 wherein the circuit for crest factor reduction is a first circuit for crest factor reduction and further comprising a second circuit for crest factor reduction, wherein the output of the first circuit for crest factor reduction is connected in series to the input of the second circuit for crest factor reduction.

47. The circuit of claim 35 wherein the extraction device in the first circuit for crest factor reduction has a first threshold and the extraction device in the second circuit for crest factor reduction has a second threshold, with the magnitude of the second threshold being lower than that of the first threshold.

48. A multicarrier data transmission system comprising:
a transmission path arranged and disposed between a transmitter and at least one transmission line, the transmission path including a digital/analog converter operable to convert a digital data symbol to an analog data symbol and a line driver operable to drive the analog data symbol via the transmission line;
at least one circuit for crest factor reduction according to claim 34 arranged in the transmission path upstream of the digital/analog converter and operable to produce a compensation signal for reduction of the crest factor of the data symbol which is to be transmitted.

49. The data transmission system of claim 48 further comprising a circuit for echo compensation arranged between the transmission path and a reception path, wherein the circuit for echo compensation is operable to account for an echo element caused by the compensation signal.
